(19) United States
(12) Patent Application Publication
(10) Pub. No.: US 2014/0263735 A1
(43) Pub. Date: Sep. 18, 2014

(54) Matched Precipitation Rate Rotary Sprinkler

(71) Applicant: Rain Bird Corporation, Azusa, CA (US)

(72) Inventors: Derek Michael Nations, Tucson, AZ (US); Douglas Scott Busch, Tucson, AZ (US)

(21) Appl. No.: 14/209,910

(22) Filed: Mar. 13, 2014

Related U.S. Application Data
(60) Provisional application No. 61/790,142, filed on Mar. 15, 2013.

(51) Int. Cl. B05B 3/08

(52) U.S. Cl. CPC B05B 3/08
USPC 239/232

(57) ABSTRACT

Rotary irrigation sprinklers capable of automatically matching precipitation rates with fluid flow rates and arc adjustments capability of maintaining a substantially constant throw radius along with various other features of the sprinkler.

### CROSS-REFERENCE TO RELATED APPLICATIONS

This application claims the benefit of U.S. Provisional Patent Application Ser. No. 61/790,142, filed Mar. 15, 2013, entitled MATCHED PRECIPITATION RATE ROTARY SPRINKLER, the contents of which are incorporated by reference in its entirety herein.

### FIELD

The field relates to irrigation sprinklers and, more particularly, to rotary irrigation sprinklers capable of automatically matching precipitation rates with fluid flow rates and arc adjustments while maintaining a substantially constant throw radius.

### BACKGROUND

Pop-up irrigation sprinklers are typically buried in the ground and include a stationary housing and a riser assembly mounted within the housing that cycles up and down during an irrigation cycle. During irrigation, pressurized water typically causes the riser assembly to elevate through an open upper end of the housing and rise above the ground level to distribute water to surrounding terrain. The pressurized water causes the riser assembly to travel upwards against the bias of a spring to the elevated spraying position to distribute water to surrounding terrain through one or more spray nozzles. When the irrigation cycle is completed, the pressurized water supply is shut off and the riser is spring-retracted back into the stationary housing.

A rotary irrigation sprinkler commonly includes a rotatable nozzle turret mounted at the upper end of the riser assembly. The turret includes one or more spray nozzles at the outer portion of the turret for distributing water while the turret is rotated through an adjustable arcuate water distribution pattern. Rotary sprinklers commonly include a water-driven motor to transfer energy of the incoming water into a source of power to rotate the turret. One common mechanism uses a water-driven turbine and a gear reduction system to convert the high speed rotation of the turbine into relatively low speed turret rotation. The turbine and various gears are normally in the riser and within the main fluid flow path.

Rotary sprinklers may also employ arc adjustment mechanisms to change the relative arcuate distance between two stops that define the limits of rotation for the turret. One stop is commonly fixed with respect to the turret while the second stop can be selectively moved arcuately relative to the turret to increase or decrease the desired arc of coverage. The drive motor may employ a tripping tab that engages the stops and shifts the direction of rotation to oscillate the turret in opposite rotary directions in order to distribute water of the designated arc defined by the stops.

There is generally a relationship between the amount of water discharged from a sprinkler nozzle relative to its range and arc of oscillation. This relationship is commonly referred to as the precipitation rate for the sprinkler, and it relates to how much irrigation water is projected onto a ground surface area defined within the arc of rotation. As the arc of rotation is increased or decreased, the flow of water through the nozzle should be adjusted accordingly so that the same precipitation rate is deposited on the ground independent of the sprinkler's arc of rotation. This concept is often referred to as a matched precipitation rate. Previously, a matched precipitation rate was achieved by switching nozzle configurations when the arc was changed by manually removing and inserting different nozzle inserts for each arc setting. As can be appreciated, this is a cumbersome task and requires multiple nozzle inserts configured for specific arcs of rotation. For example, a sprinkler may have one nozzle insert for a 45° arc of rotation and a different nozzle insert for a 90° arc of rotation. For non-standard arc settings (such as a 67° arc of rotation for example), there may not an appropriate standard-size nozzle insert to achieve matched precipitation. Thus, in many instances, the non-standard arc settings often rely on a less then desired nozzle insert that may be mismatched to the selected arc of rotation. That is, a 67° arc of rotation may need to rely on a 45° or a 75° nozzle insert, but such nozzle insert may not be tailored to provide a desired precipitation rate for a 67° arc of watering.

When attempting to achieve consistent or matched precipitation for changes in the arc of rotation, however, it can be difficult to adjust flow volume to achieve matched precipitation without negatively affecting range. For example, when the arc of watering is increased, the flow rate typically needs to be increased to achieve the same precipitation; however, increases in flow rate also tend to lead to an undesired increase in throw radius. Likewise, when decreasing arc of coverage, the flow generally needs to be decreased, but this tends to lead to a shorter throw radius. Thus, there is often a shortcoming in rotary sprinklers when attempting to achieve matched precipitation because it may be difficult to maintain a substantially constant throw radius when the sprinkler is automatically adjusting flow to match precipitation.

### BRIEF DESCRIPTION OF THE DRAWINGS

FIG. 1 is a graph of flow versus nozzle sweep pattern;

FIG. 2 is a perspective view of an exemplary rotary sprinkler;

FIG. 3 is a perspective view of an exemplary deflector;

FIG. 4 is a cross-sectional view of an exemplary rotary sprinkler;

FIG. 5, which includes subfigures 5A-5C, is a front view of an exemplary deflector;

FIG. 6, which includes subfigures 6A-6C, is a cross-sectional view of the deflectors of FIG. 5;

FIGS. 7 and 8 are perspective views of another exemplary deflector;

FIG. 9 is a cross-sectional view of the deflector of FIGS. 7 and 8;

FIG. 10, which includes subfigures 10A and 10B, is perspective views of a rotary sprinkler nozzle;

FIG. 11, which includes subfigures 11A-11C, is perspective views of an adjustment mechanism for the nozzle of FIG. 10;

FIG. 12, which includes subfigures 12A-12C, is perspective views of a rotary sprinkler nozzle;

FIG. 13 is a cross-sectional view of a rotary sprinkler and nozzle;

FIG. 14 is a perspective view of an alternative exemplary nozzle;

FIGS. 15 and 16 are top and cross-sectional view of the alternative exemplary nozzle of FIGS. 14;

FIG. 17, which includes subfigures 17A and 17B, is cross-sectional views of another rotary sprinkler nozzle;

FIG. 18, which includes subfigures 18A-18C, is top views of the nozzle of FIG. 17;

FIG. 19, which includes subfigures 19A-19C, is cross-sectional views of the nozzle of FIG. 17;

FIG. 20 is a perspective view of another rotary sprinkler nozzle;

FIG. 21, which includes subfigures 21A and 21B, is top and cross-sectional view of the nozzle of FIG. 20;

FIG. 22 is a cross-sectional view of another exemplary rotary sprinkler nozzle;

FIG. 23, which includes subfigures 23A-23C, is perspective views of the nozzle of FIG. 22;

FIGS. 24A and 24B are perspective views of another exemplary rotary sprinkler nozzle;

FIG. 25 is a partially exploded perspective view of another exemplary rotary sprinkler nozzle;

FIGS. 26 and 27 are perspective views of the nozzle of FIG. 25;

FIG. 28 is a perspective view of an exemplary turbine for a rotary sprinkler;

FIG. 29 is a cross-sectional view of a rotary sprinkler deflector and turbine;

FIG. 30, which includes subfigures 30A-30C, is cross-sectional and perspective views of a rotary sprinkler and turbine therefor;

FIG. 31 is a cross-sectional view of a rotary sprinkler, deflector, and turbine;

FIG. 32 is a partially exploded reversing mechanism for a rotary sprinkler;

FIG. 33 is a top plan view of the reversing mechanism of FIGS. 32;

FIG. 34 is a top plan view of a biasing element for the reversing mechanism of FIG. 32;

FIGS. 35A, 35B, and 35C are perspective view of a rotary sprinkler;

FIG. 36 is a cross-sectional view of a rotary sprinkler;

FIG. 37 is another cross-sectional view of a rotary sprinkler; and

FIG. 38 is a perspective view of a filter basket for a rotary sprinkler.

### DETAILED DESCRIPTION

A rotary sprinkler is described having a substantially matched precipitation rate. The rotor, in some aspects, will provide scheduling coefficients of about 1.2 or below, a distribution uniformity of about 80 percent or greater, a precipitation rate of about 0.4 to about 0.6 inches/hour, and an adjustable fluid throw radius between about 8 and about 32 feet. Provided herein are various aspects of a deflector system, nozzle assembly, turbine, reversing mechanisms, and other features of a unique rotary sprinkler.

In order to achieve a substantially constant or matched precipitation rate independent of the arcuate sweep of the sprinkler and/or throw radius, the fluid flow from the sprinkler generally needs to vary by a factor of about four in order to cover a resulting change in arcuate area. In the present case, the flow rate tends to change linearly with an increase or decrease in the arcuate sweep of the watering. As shown in FIG. 1, a general representation of the fluid flow through a nozzle and deflector relative to the distance and arcuate sweep is provided to achieve a constant precipitation rate for the sprinklers. For instance, based on this representation, substantially the same amount of fluid flow (labeled A) for a quarter circle watering pattern at 32 feet radius is the same amount of flow generally needed for a full circle watering pattern at 16 feet radius (labeled B). Thus, the challenge with matched precipitation sprinklers is to configure a rotary sprinkler that can provide automatic or matched precipitation independent of arc of coverage while maintaining a substantially constant throw radius because the flow needed for a given precipitation rate at one arc of coverage may normally be associated with a much farther throw radius. Moreover, as shown by the representation in FIG. 1, the range in flow for a quarter circle (¼ sweep) is much smaller than the range of flow for a full circle watering pattern (1 or full sweep), which adds further challenges to forming a sprinkler that automatically adjusts flow to maintain a precipitation rate without affecting throw radius.

In one aspect, the rotors herein are configured to provide automatic and substantially matched precipitation independent of the arcuate sweep of the rotor and/or independent of the radius of fluid throw through the automatic adjustment of one or more rotor features incident to adjustment of the arc of coverage. One component to achieve such functionality is selection and variation of the deflector element of the rotor. In the rotors of the present disclosure, the deflector is downstream of the nozzle assembly and sized, shaped, and configured to direct or channel the flow of water from the sprinkler nozzle to a ground area based on flow input from the nozzle, among other features, in an amount consistent with the matched precipitate rate requirements and throw distance. The nozzles herein include structure and elements to vary, among other features, fluid turbulence, fluid disturbance, and/or fluid noise to help define the desired fluid pattern and range for watering.

In another aspect, the rotors include a variable shape and size nozzle assembly upstream of the deflector to provide and direct the necessary flow amount to the deflector in order to achieve the desired matched precipitation rate for a given throw radius. In general, the nozzle assembly includes a nozzle configured to control and structure the water flow, velocity, and focus to the deflector in order to define and form the proper stream geometry and energy to achieve the desired matched precipitation rate and throw radius. The nozzle is configured to alter its shape, geometry, and focus as needed automatically incident to an arc adjustment to form the proper fluid flow stream, precipitation rate, and throw radius.

In yet another aspect, the rotary sprinklers herein may also include unique turbine components that use the energy from the flowing water to generate rotation of the sprinkler head. In some approaches, the turbine is positioned downstream of the nozzle and deflector and located in the rotary head of the sprinkler. The turbine is linked to a gearbox that reduces the speed and increases the torque to generate sprinkler head rotation. In some approaches, the turbine is positioned to minimize and avoid a pressure drop in the fluid.

In yet another aspect, the sprinkler may include a unique reversing mechanism that is coupled to the turbine and positioned outside of the main fluid flow path. The reversing mechanism may include, in some approaches, a planetary switching mechanism and/or include a stamped spring to effect reversing rotation of the sprinkler. The reversing mechanism is thin and minimizes the amount of head space needed for its operation.

Turning to more of the specifics and as generally shown in FIGS. 2-4, one approach of a rotary pop-up sprinkler 10 is provided that includes a housing 12 having a longitudinal axis X, a pop-up riser assembly 14 coupled with the housing 12, and a rotatable nozzle turret 16 on an upper end 18 of the riser assembly 14. In one aspect, the sprinkler 10 includes an arc setting assembly that enables reversing, part-circle operation of the turret 16 or full-circle operation of the nozzle turret 16.

In another aspect, the sprinkler 10 may also include a deflector and nozzle combination having automatic matched precipitation with the arc setting mechanism. To this end, as one or more of the arc stops used to define opposite arcuate ends of the watering path are adjusted, the nozzle is operative to automatically adjust its configuration to correctly compensate the geometry of the nozzle opening to vary the precipitation rate for the selected arc of watering in combination with various features of the deflector downstream of the nozzle. Thus, the nozzle may have matched precipitation for one or both of the adjustments to flow rate and/or arc of coverage.

In general, the riser assembly 14 travels cyclically between a spring-retracted position where the riser 14 is retracted into the housing 12 and an elevated spraying position where the riser 14 is elevated out of the housing 12 (FIG. 2). The riser assembly 14 includes the rotatable nozzle turret 16 having at least one deflector or deflector assembly 24 therein for distributing water over a ground surface area. When the supply water is on, the riser assembly 14 extends above ground level so that water can be distributed from the deflector 24 over the ground surface area for irrigation. When the water is shut off at the end of a watering cycle, the riser assembly 14 retracts into the housing 12 where it is protected from damage.

The housing 12 generally provides a protective covering for the riser assembly 14 and serves as a conduit for incoming water under pressure. The housing 12 preferably has the general shape of a cylindrical tube and is preferably made of a sturdy lightweight injection molded plastic or similar material. The housing 12 has a lower end 26 with an inlet 28 that may be coupled to a water supply pipe (not shown). The sprinklers illustrated herein are only exemplary and may take other shapes and configurations as needed for a particular application.

As generally shown in FIG. 2, the riser assembly 14 includes a non-rotatable riser stem 32 with a lower end 34 and an upper end 18. The rotatable turret 16 is rotatably mounted on the upper end 18 of the riser stem 32. The rotatable turret 16 includes a housing 36 that rotates relative to the stem 32 to water a predetermined pattern, which is adjustable from part-circle, reversing rotation or to full-circle, non-reversing rotation. In some approaches, such as shown in FIG. 2 and later in FIGS. 35A, 35B, and 35C, the turret 16 and housing 36 provide a dual pop-up functionality where the turret 16, housing 36, and deflector 24 elevate out of the riser stem 32 to expose the deflector 24 for watering. In this manner, when water is provided to the sprinkler 10, the water pressure causes the riser 14 to elevate out of the housing and also causes the turret housing 36 to elevate out of the riser to effect watering. FIG. 2 shows the turret housing 36 in the elevated or watering position. In this manner, the sprinkler 10 can provide a much larger flow exit area in the deflector 24 than typical nozzles in rotary sprinklers.

The riser stem 32 may be an elongated hollow tube, which may be made of a lightweight molded plastic or similar material. The lower stem end 34 may include a radially projecting annular flange used to retain the riser in the housing. The flange preferably includes a plurality of circumferentially spaced grooves that cooperate with internal ribs (not shown) of the housing 12 to prevent the stem 32 from rotating relative to the housing 12 when it is extended to the elevated position under normal operation, but can be ratcheted when torque is applied to the riser 12. A coil spring for retracting the riser assembly 14 back into the housing 12 is disposed in the housing 12 about an outside surface of the riser assembly 14. A coil spring or other biasing mechanism may also be used to elevate and retract the turret housing 36 to expose the deflector 24 for water in the dual pop-up functionality.

Multifunctional Deflector

Turning to more of the specifics on the deflector and to FIGS. 3 to 9, the deflector 24 may be configured to channel and adjust the flow of water to a set ground surface area consistent with desired matched precipitation rate requirements while maintaining a substantially constant throw radius. In FIG. 3, one example of a deflector 24 is shown. In this approach, the deflector includes a body 30, such as a cylindrical wall 32 defining an internal passage or cavity 33 that is configured to receive water from the sprinkler nozzle. The body wall 32 defines an outlet or opening 34 having one or more downwardly extending vanes 36 at the outlet opening 34. In FIG. 3, three vanes 36 are shown, but more or less can be included as needed for a particular application. The vanes 36 help define the flow characteristics by, in some approaches, helping to straighten out the flow.

FIG. 4 shows an example of the deflector 24 within a rotor assembly 10. In this approach, the deflector 24 is mounted for movement with the pop-up turret 16 and is coupled thereto on an upper end and mounted for shifting at the deflectors' lower end in the sprinkler riser 14. In this view, the cavity or passage 33 is shown having a rear or back curved wall 38, which is opposite the outlet opening 34. The deflector 24 is substantially above or coaxial with a nozzle 40 and accepts fluid from the nozzle and deflects the fluid flow outwardly to water the ground surface area.

The deflector 24 may also have a tiered outlet configuration as generally shown in FIGS. 3, 5, and 6. In this approach, the outlet 34 has a staged shape or profile with a variety of sectors or tiers to allow variations in the fluid stream distribution depending on where the flow is hitting the different tiers when directed thereto from the back wall 38. Thus, the tiers can help control the range, distribution, and trajectory of the flow. As shown in FIG. 5, the deflector outlet defines three tiers (but, deflectors may have more or less tiers as needed for a particular application). In FIG. 5A, a small deflector 39 is provided by a first level or tier 42 in the central portion of the deflector outlet opening 34. In FIG. 5B, an intermediate deflector 44 is formed when the fluid stream is directed to a second or medium zone or tier 46 that includes the first tier 42 and additional side zones 48 of the outlet on each side of the first tier 42. Lastly, in this exemplary approach, a large deflector 50 is provided by a large zone or tier 52 that includes the opening area defined by both the first and second tiers 42 and 46 as well as additional side zones 54 forming the largest deflector outlet opening. As shown, the side zones can be axially shorter openings in the outlet on either side of the main outlet opening.

As shown in FIG. 6, utilization of the various tiers 42, 46, or 52 can be obtained by the direction, focus, and shape of the fluid flow from the nozzle 40 to the deflector rear wall 38. In FIG. 6A, fluid is directed from an upstream small or narrow nozzle 40 towards the center of the back wall 38 to focus fluid on the first tier 42. In FIG. 6B, the nozzle 40 opening size is increased and/or the direction of the nozzle 40 is changed so as to focus and spread out the flow stream on the back wall 38 more to utilize the second tier 46 outlet. Likewise, in FIG. 6C, the largest nozzle 40 opening is utilized to spread out the fluid to the deflector wall 38 in order to utilize all tiers and the largest outlet opening 52.

In another approach, the deflector 24 may also include a variety of exit ports and internal channels in order to focus and direct the flow. FIGS. 7-9 provide an example of a multi-port and multi-channel deflector assembly 24, which is arranged and configured to expose a variable number of outlet ports 60 depending on the axial extension of the deflector 24 and turret 16 relative to the riser stem 14. For instance, FIG. 7 shows the turret 16 and deflector 24 partially extended in an axial direction out of the riser 14 to expose a first portion of the deflector ports 60, which shows an exemplary seven ports exposed and open for directing water. FIG. 8, on the other hand, shows the turret 16 and deflector 24 fully extended exposing all nine exemplary deflector ports 60. More or less ports can be provided as needed in a particular application. It will, of course, be appreciated that any number of deflector ports can be exposed depending on the particular orientation of the ports on the deflector and the axial extent of the displacement of the deflector out of the riser stem 14. In this exemplary approach, the deflector ports include a central port 60a and two tiers of secondary ports 60b and 60c in rows below and to the sides of the central port 60a (FIG. 8.) Other configurations of the ports are also possible. In addition, as shown in FIG. 8, the deflector wall may also define edges of the ports having different shapes, sizes, and areas as needed to craft a specific flow pattern depending on the position of the port on the nozzle wall.

FIG. 9 is an exemplary cross-sectional view of the deflector 24 having a multi-port and discrete channel configuration. In this approach, each port 60 is associated and in fluid communication with a distinct and separate flow channel 62 in the deflector 24. Thus, as the nozzle 40 changes the shape, size, and direction of the fluid flowing to the deflector 24, the fluid will enter different flow channels 62 depending on the focus and direction of the flow to the deflector. As shown, each flow channel 62 has an inlet opening 64 at the bottom of the deflector and extends through the deflector body toward a curve or elbow 66 that directs the flow to the outlet port 60. In this approach, the stream of fluid from the nozzle 40 is separated and isolated in the various deflector channels 62 and then re-combined at the deflector outlet or exit 34. This configuration of the deflector minimizes fluid turbulence because the flow is directed through one or more individual, isolated, and narrow channels 62 capable, in some approaches, of minimizing turbulence and, in other approaches, in view of the diameter and length of the channels relative to the fluid velocity achieving generally laminar flow of the fluid. The channels may be configured to hold generally laminar flow or create varying levels of turbulence as needed for a particular application.

In this discrete channel deflector assembly, the upstream nozzle 40 controls and directs the flow into a select number (or all) of the channels 62 as needed to achieve the desired precipitation rate and throw radius. These channels keep the flow separate and not allowing the various streams to re-combine until after it exits from the deflector 24. By one approach, a top channel 63 (FIG. 9) has the cleanest flow and largest trajectory angle Z (relative to the ground or horizontal). The channels below the top channel 63, such as channel 65, may decrease in trajectory angle Y (relative to the ground or horizontal) and would thus tend to add fluid volume to the stream exiting the deflector but not necessarily range to the combined flow because these lower channels have a lower trajectory angle. In this approach, a pop-up or wiper seal 67 and/or 69 may be utilized (FIG. 7 and FIG. 15) that is effective for 360° rotation to seal or block off all channels that are not to receive water. This seal may also sweep grit away when retracting the turret 16 when water is shut off to the sprinkler. The individual changes may also be configured differently so that certain channels project a flow stream with a generally laminar flow while other channels and ports project a flow stream with a turbulent flow.

Adjustable Nozzle Assembly

As generally shown previously in FIG. 4, the rotary sprinkler 10 includes an adjustable nozzle 40 upstream of the deflector 24. The nozzle is configured to vary in shape, size, orientation, and focus to control the amount and direction of fluid able to flow through the sprinkler at a given time to adjust for the matched precipitation rate and change in fluid velocity to maintain throw radius. FIGS. 10-27 show various examples of an adjustable nozzle 40.

In FIGS. 10 to 13, a nozzle 40 is provided including an adjustable nozzle assembly 72 having a plurality of adjustable petals or leaves 71 encircling a nozzle opening 73 that can be opened or closed to vary the size and shape of a nozzle outlet 73. In one approach, the nozzle 40 uses petal shaped overlapping lobes 71 formed out of metal, plastic, or other resilient sheet material. The nozzle opening size is adjusted by a translating mechanism 80 that adjusts the axial position of each individual petal or lobe.

FIGS. 10A and 10B show the petal-based nozzle in more detail. The nozzle assembly 72 includes an annular ring base 74 having one or more of the lobes 71 extending inwardly and upwardly from the ring base 74. To form a complete nozzle 40, two circumferentially shifted assemblies may be nested together to form a complete nozzle as generally shown in the images of FIG. 12. Each nozzle lobe 71 is resiliently joined to the ring base 74 at a pivot or living hinge portion 76, which permits the lobe to pivot upwardly to increase the size of the outlet 73 or be pushed downward and inwardly to close or restrict the size of the outlet 73 as generally shown in the exemplary views of FIGS. 12A-12C. In this approach, the sprinkler 10 also includes a central mounting shaft 100 to which the nozzle turret 16 is mounted to. The nozzle is configured about this shaft with the petals arranged and configured to shift inwardly and outwardly toward or away from the shaft 100 when adjusting the nozzle opening 73 size. Thus, the outlet 73 size and shape is formed by the distal ends of each petal and the outer circumferential wall of the shaft 100. The farther the petals 71 are from the shaft, the larger the nozzle opening 73 (FIGS. 12-12C).

FIG. 11 shows one example of a translating mechanism or basket 80 that couples with the various lobes 71 to adjust the axial position thereof. In this approach, the mechanism 80 includes an annular or ring shaped support 82 to which downwardly depending arms 84 extend in a radial direction from the outer support ring 82 to an inward support ring 86. Each arm extends in a radial direction and has a tapered or curved lower profile 88. Each arm 84 is positioned circumferentially about the support 82 to correspond to one of the lobes 71 in the nozzle assembly 72. The basket 80 is shiftable up or down to either push the lobes 71 down to close the nozzle or allow the lobes 71 to flex outwardly under fluid pressure to open up the nozzle 72. As shown by the cross-sectional views of FIGS. 11B and 11C, the tapered or curved lower profile is more clearly visible. This tapered or curved lower profile 88 engages the upper lobe surface and provides a non-linear adjustment of the nozzle opening 73 in some approaches, which permits finer adjustments with small opening sizes and larger adjustments for larger opening sizes.

As shown in FIGS. 12 and 13, the translating mechanism 80 is positioned to shift or slide axially within the sprinkler 10 about the shaft 100 (which extends through a hole or aperture 90 in the inwardly support ring 86) to shift the axial position of each lobe 71 up or down within the nozzle assembly 72. FIG. 12A shows the mechanism 80 is a fully lowered position so that it squeezes the lobes 71 to a fully lowered position resulting in the smallest nozzle outlet 73. FIG. 12B shows the mechanism 80 shifted axially up in the sprinkler to an intermediate position whereby the basket is moved axially upwardly and away from the lobes 71. As each lobe is biased inwardly, movement of the basket upwardly combined with the fluid pressure flowing through the nozzle forces the lobes 71 against the edge 88 to a more open position. FIG. 12C shows the basket 80 shifted axially upward to its fully open or largest nozzle opening 73 allowing the lobes 71 to pivot or shift open it their fullest.

Instead of the petal configuration, the nozzle 40 may be formed via a tilting nozzle 100 (FIGS. 14-16) utilizing an iris-like assembly with two pivoting iris halves 102 and 104 that shift or pivot toward or away from each other to change the diameter, shape, and direction of the fluid flow through the nozzle 40. The iris halves 102 and 104 can be both pivoted simultaneously to simply change the size or diameter of the opening or, alternatively, one iris half can be pivoted or shifted more or less than the other to change not only the size and diameter of the opening, but also the direction of the fluid flow as generally shown in FIGS. 15 and 16. This configuration is advantageous because it can be one example of a nozzle configured to shift the focus of the fluid flow to the various or selected portions of the deflector 24 as discussed above. The uniqueness of the nozzles herein is their ability to adjust as needed in order to focus or aim the flow out of the nozzle to a desired portion of the deflector making the nozzle an active nozzle rather than just a passive nozzle that simply constricts or increases the fluid flow. In one approach, the iris may open and close as the nozzle housing 36 is shifted axially up or down. Other approaches to shifting of the iris may also be used.

As shown in FIGS. 15 and 16, depending on how the iris is shifted, the focus of fluid flowing through the iris may change. For example, in FIG. 15, the iris is shifted to a teardrop or eye-like shaped opening 73 to focus the flow on the small nozzle setting or first tier 42. This configuration can be obtained by shifting one iris half relative to the other. Alternatively, as shown in FIG. 16, both halves of the iris may be shifted to a large opening to focus flow on all portions of the deflector 24 to utility the large or third tier 52.

The sprinkler may also include a non-symmetric nozzle 40 to focus and direct a fluid stream to designated portions of the deflector 24, as discussed above. FIGS. 17-19 show one example of a non-symmetric nozzle 40. In one approach of the non-symmetric nozzle, the nozzle assembly 72 with the various lobes 71 may be utilized, but one or more of the lobes 71 may be removed to form a gap or other opening 120 (best shown in the images of FIG. 18) in the nozzle assembly, which forms the non-symmetrical opening. Greater fluid flow will pass through this gap 120 even when the remaining lobes are closed. Further, even when the lobes 71 are fully open, this additional gap can, in some approaches, direct more flow therethrough to certain portions of the deflector 24 thereabove. In one approach and as shown in FIGS. 18A and 19A, the gap 120 in the lobes 71 may be aligned with the front, center portion 122 of the deflector 24 and the first tier 42 of the deflector. This configuration will provide the cleanest and most laminar flow through the deflector, which may be associated with the range and rotation with the smallest flow.

In some approaches, the non-symmetric nozzle takes advantage of two separate adjustment systems to adjust range and matched precipitation. For instance, as shown in FIGS. 17A and 17B, the non-symmetric nozzle may be a cooperation of the nozzle assembly 72 combined with an adjustable height axially shiftable plunger 124. The plunger 124 may be used to set the range of the sprinkler by increasing or decreasing volume of the fluid flow and the nozzle assembly 72 may be used to fine tune the velocity and focus of the flow to the deflector 24. As shown, the plunger 124 may be a plug valve that is mounted for axial movement along the shaft 100 and may have a valve seat 126 spaced axially upstream via a spacer block 128 from the nozzle assembly 72. The spacer block 128 is advantageous because it forms a flow cavity 130 between the valve seat 126 and the nozzle assembly 72. The volume of the flow cavity 130 permits fluid turbulence and flow to settle out prior to hitting the nozzle, which aids in control of the flow through the nozzle. FIG. 17A shows the plunger 124 retracted from the valve seat 126 and in a full range setting. FIG. 17B shows the plunger 124 adjacent and close to the valve seat 126 in a minimum range setting. The plunger 124 may also be fully closed and engaged to the valve seat 126 to shut off flow.

After adjustments of the plunger 124, the nozzle can further define and focus the flow to the deflector 24. FIGS. 18 and 19 illustrate how the non-symmetric nozzle can alter the shape and focus of the flow. FIGS. 18A and 19A show the nozzle assembly 72 in a fully closed position where the lobes 71 are adjacent to the shaft 100 (not shown in FIG. 18) to focus the flow mainly through the gap 120 to the front and center portion 122 of the deflector 24. In FIGS. 18B and 19B, the nozzle assembly 72 is partially open with the lobes 71 retracted outwardly. In this configuration, fluid will still flow through the opening 120, but will have a larger opening 73 between the ends of the lobes and outer wall of the shaft so that the flow will engage additional portions of the nozzle 24 to utilize the second nozzle tier 26 (or additional ports 60), for example, to craft a second fluid stream pattern. FIGS. 18C and 19C show the nozzle fully open to utilize the full passageway and all portions of whatever deflector 24 is being used.

FIGS. 20 and 21 show another example of an adjustable nozzle 40 for the sprinkler. This nozzle is a multi-port and multi-channel nozzle having a series of ports and associated channels that may function individually or together to act as a nozzle. Some of the ports may be different sized than others depending on the position on the nozzle, which permits different flows through various ports to interrupt one another and cause range and distribution flow changes. In some approaches, the ports and different sizes can be grouped to be opened or closed in various combinations to create different flow rates and geometries of the flow through the nozzle. The resulting exit stream will then produce a variety of distribution patterns. To this end, the nozzle may include doors or other blockages on each of the ports to open and close various ports as needed to craft a particular flow geometry.

The multi-port nozzle 40 may have a cone body 149 with a central aperture 150 for receiving the sprinkler shaft 100 (not shown in FIGS. 20 and 21). The nozzle defines one or more ports 152 along an inwardly tapered side wall 154 extending inward to the aperture 150 from a base ring 155. Each port may include a cover or door 156 (a few are highlighted in FIG. 20) that can be actuated open or closed as needed to expose one or more individual ports 152 to fluid. Each set of ports 152 and doors 156 may be axially aligned in sectors along the side wall 154. Each port 152 leads to a separate flow channel 158 internal to the nozzle 40, which isolates fluid flow through the nozzle. In this regard, the flow is separated through the various open ports and through the associate channel 158 creating a clean and, in some approaches, a laminar flow therethrough. At the downstream side of the nozzle, the isolated, individual flows in each open port and channel are then recombined prior to entering the downstream deflector 24.

FIGS. 21A and 21B show how opening and closing various ports 152 can create different stream patterns and geometries and direct different types of flow to the nozzle 24. For example FIG. 21A shows only one front port 152A open to direct flow through only a single channel 158, which can focus flow to the center front portion of the nozzle 24. In FIG. 21A, all other ports 152 are closed. In FIG. 21B, two front ports 152A and two sectors of rear ports 152B (a total of six rear ports) are open for flow. The other ports are closed. This forms a different flow geometry to the nozzle 24. In some approaches, this nozzle digitizes the flow into discrete flow patterns through the nozzle and can craft flow to different portions of the deflector 24 as needed based on which ports are opened and closed. As can be appreciated, a variety of patterns can be constructed. In the exemplary nozzle shown, it includes 40 individual ports that can be rectangular shaped or, in some approaches more triangular shaped. It will be appreciated that different numbers of nozzle ports can be used.

The nozzle 40 may also be a telescoping or stacking nozzle having a series of concentric nozzle cones 160 that extend or retract to change the shape, form, and diameter of the nozzle outlet. The nozzle cones 160 interlock to form a variety of nozzle sizes and geometries. FIGS. 22 and 23 show an example of such a telescoping nozzle utilizing five interlocking cones (identified as 160a, 160b, 160c, 160d, and 160e), but other numbers may be used as needed for a particular application.

In this form of the adjustable nozzle, the series of concentric nozzle cones 160 shift up or down axially individually to each other in order to change the shape of the nozzle outlet. For example and as shown in the image of FIG. 23B, the nozzle 40 has its largest flow opening as all of the nozzle cones 160 are retracted axially down. The adjustable nozzle 40 decreases its orifice size by telescoping up individual nozzle cones 160 into engagement with an adjacent outer cone 160. For instance, the one cone 160b would be telescoped up into engagement with an adjacent cone 160a to reduce the nozzle orifice size. Subsequent inner nozzle cones can be further telescoped up to reduce the nozzle orifice further. A plunger or adjustment cone 164 (FIG. 22) is selectively connected to the individual nozzle cones 160 (and a central adjustment shaft 100) and configured to telescope up individual cones similar to the ratchet mechanism in a click-type ball point pen.

As shown in FIG. 22, each cone 160 may include one or more resilient fingers 166 at a lower end thereof that are receivable in an annular slot 168 in the plunger cone 164. There may be a different annular slot 168 for each cone 160. The slots may be spaced axially along a tapered side wall of the plunger cone 164. As the plunger cone 164 is turned or rotated, individual fingers 166 are released from the slot 168 (the slot may have a tapered surface or be cammed to release the fingers). Once the fingers 166 are released from its associated cone slot 168, the cone 160 will extend upwardly to reduce the size of the nozzle 40. By one approach, each cone 160 may be biased with a coil spring or other biasing member 170 to permit upwardly shifting of a released cone.

To rotate the plunger cone 164, notches 172 may be provided in a lower surface thereof that are connectable to an adjustment mechanism (not shown). To reset the nozzle, the plunger cone may be activated or pushed upwardly whereby the fingers 166 of each cone would resiliently deform outwardly and then snap back into its respective slot 168, when the cone 164 is then retracted back to its home position, each nozzle cone would be retracted back to form a nozzle with the largest opening. FIG. 23A shows the nozzle with all cones 160 released to shut off flow. FIG. 23B shows all cones 160 retracted to form the largest opening. FIG. 23C shows all but the last cone 160a released forming the smallest nozzle opening and the minimum flow.

Yet another type of adjustable nozzle 40 using telescoping cones would utilize a rotate and lock-type tab and slot system to activate and deactivate each nozzle instead of the ratcheting system described above. FIGS. 24A and 24B provide an example showing three interlocking cones 170a, 170b, and 170c, which are concentrically received internally to each other. Each cone includes a slot 172 and a lock tab 174 received in the slot of an outer cone. Each slot includes an axial portion 176 and a locked or rotate-cam portion 178. FIG. 24A shows cones 170a and 170b in an intermediate position as the tabs 174 are within the axial slot portion 176 indicating that these cones are being shifted in an axial direction. FIG. 24B shows cone 170a axially shifted downwardly to decrease the size of the nozzle opening. Here, cone 170a is shifted axially downwardly and rotated to lock the tab 174 in the lock portion 178 of its associated slot 178. It will be appreciated that the shifting of the other cones will be similar.

In yet another approach of an adjustable nozzle 40, the nozzle 40 may include a resilient or flexible nozzle tube 180 that is configured to be constricted by tightening a band 182 or other member wrapped around the tube 180 as best shown in FIGS. 25, 26, and 27. In this exemplary approach, the sprinkler 10 may include an adjustment shaft or screw 184 accessible on an outer portion of the riser 14 (for example) that either tightens or loosens the band 182 around the resilient nozzle tube 180 to increase or decrease the cross-sectional area of the adjustable nozzle 40. As shown, one end 182a of the band 182 is fixed to a rotatable shaft or tube 186 coupled to the adjustment screw 184 (by a geared relationship, for instance), and a second end 182b of the band 182 is fixed to a portion of the fixed or non-rotating sprinkler housing, such as the fixed or non-rotating housing member 188 for example (in FIG. 25, the housing member 188 is shown exploded away for clarity; when assembled, the band end 182b is attached to the bore 190 in the housing member 188). As the screw 184 is turned, the shaft or tube 186 is rotated via the geared mating relationship shown in FIG. 23. As the shaft 186 rotates, the band 182 is either constricted or relaxed over the resilient tube 180 to vary the size or diameter of the nozzle orifice area. As shown in FIG. 25, the resilient tube 180 may include mating pegs 192 configured to be received in a key-slot holes 194 in the housing member 188. In this manner, the lower end of the tube 180 is mounted to a fixed portion of the sprinkler and does not rotate.

Turbine Components

The sprinkler 10 may also include a unique turbine 200 that is positioned out of the main fluid flow path. In one approach, the turbine uses energy from the flowing fluid in the deflector 24 to generate rotation of the rotor. The turbine is linked to a gearbox that reduces the speed and increases the torque to generate rotation. FIGS. 28, 29, 30, and 31 illustrate examples of this unique turbine 200 and its location in the sprinkler 10.

As shown in FIG. 28, the turbine 200 has a central hub 202 with a plurality of radially extending arms 204 to which downwardly depending turbine blades 206 are attached to radially distal ends of the arms. The arms 204 are thin compared to the blades 206 such that when fluid flow hits the blades 206 (and the turbine speeds up), the arms 204 and blades 206 flex upwardly from the pressure of the water and torque of spinning. This resilient and changing nature of the turbine is advantageous because it enables the turbine to provide maximum torque at initial turning of the turbine or start-up of the sprinkler (when the blades project down fully) and then as the sprinkler is within normal operating conditions, the arms and blades 206 flex upwardly and reduces the amount of water that impacts the blades, generating less torque. Further, the deflection of the blades 206 may be manipulated to control the rotation speed of the rotor. When the thrust load is increased, the blades 206 deflect away from the water jet, thus assisting with maintaining a constant speed over a range of flows and nozzle orifice sizes. FIG. 30C shows the turbine in an initial or unloaded configuration at sprinkler start-up, and FIG. 30B shows the turbine in a loaded or flexed configuration during normal operation with the blades 206 flexed upwardly.

FIGS. 29, 30A, and 31 illustrate the unique placement of the turbine 200 in the sprinkler 10 as a turret-mounted drive system whereby the turbine 200 is placed outside of the main fluid flow path and in the upper portion of the nozzle turret 16. As shown, the turbine 200 is above the deflector 24 and arranged and configured so that the blades 206 pass in front of at least an upper portion of the deflector 24. This configuration positions the turbine 200 at the exit of the deflector allowing high velocity fluid to impact the blades 206 after exiting the deflector 24. In this position, the fluid exhibits a minimal pressure drop as it engages the turbine 200.

As shown in FIG. 29, this configuration utilizes fluid to generate rotor motion, but then reuses the flow as it rejoins with the major portion of fluid exiting the deflector 24. As shown, the deflector 24 may include a secondary or turbine flow passage 210 that separates and isolates a portion of the fluid flowing through the deflector upwardly and outwardly to engage the depending turbine blades 206. This so-called turbine flow A or turbine flow path 210 utilizes a small portion of the flow in the deflector to impact the blades and turn the turbine. After impacting the blades, the turbine flow A is rejoined with the standard flow B that passes through the main passage of the deflector 24. FIG. 30A shows the turbine flow A deflecting or bending upwardly C the turbine blades 206.

Reversing Mechanism

The sprinkler 10 may include a drive mechanism 250, such as a gear-drive assembly, having the water-driven turbine 200 that rotates a gear train or a speed reduction gear drive transmission 253 with, for example, a variety of systems such as a reversing turbine (flow reversing), reversing gears, planetary reversing gears to suggest but a few (see, e.g. FIGS. 4 and 31 for instance). The gear drive mechanism may include planet gears and sun gears for turning the nozzle turret 16. An example of a suitable speed reduction gear drive transmission may be similar to that described in U.S. Pat. No. 6,732,950, which is incorporated herein by reference.

In one approach, the sprinkler 10 may include a unique planetary reversing system 300 using a stamped spring and latch system to select which directional gear from the gear box to rotate. FIGS. 32, 33, and 34 show exemplary components of a planetary reversing system 300 utilizing a ring housing 302 fixed to the rotating turret 16 (not shown in these views) and, therefore, mounted for rotation therewith. The ring housing 302 includes an annular body 304 having a ring-shaped upper wall 306 and a cylindrical depending side wall 308. Projecting inwardly from an inner surface of the depending side wall 308 is a fixed stop assembly 310 including a biasing element 312 and a stop element 314. Next, the system 300 includes a stamped omega-type spring 320 coupled to the gear drive system and mounted to shift back and forth in the nozzle turret 16 to effect reversing turret rotation. Underneath the spring 320 is a reversing plate 330 that also shifts back and forth to effect reversing rotating of the turret 16. The system 300 also includes an adjustable ring gear 332 in the form of a ring 334 with gear cogs 336 defined on an outer surface thereof. An inner surface of the ring 334 defines an inwardly projecting finger 340 that forms the second, adjustable stop of the reversing system 300.

Momentarily turning to FIG. 34, the stamped omega-type spring 320 is shown in more detail. This spring may be stamped out of a thin, single sheet of metal or other resilient material. It has a base 350 and a central annular hub 352. The base 350 defines a slot 353 oriented at an angle or transverse to the main base portion 350. Extending outwardly from opposite sides of the base 350 are two opposing resilient arms 354 and 356 that curve inwardly along the hub 352 (on opposite sides thereof) and have distal ends 358 and 360 (of each arm) that terminate spaced from each other. Each arm 354 and 356 has a shoulder 362 and 364 at the distal ends 358 and 360. The shape of each arm is unique because they are configured to resiliently bend inwardly at proximal ends 366 and 368 thereof to store energy as the spring is moved towards a center tripping position. After the energy is stored in the spring, it is then used to snap the gear drive system over center, switching turret movement back and forth. The spring 320 also includes a small retention feature 370, such as a bump or protrusion, on the interior of the hub 352 that acts as a temporary retention feature, holding it on one side as the system starts to actuate.

Turning back to FIG. 33, operation of the reversing mechanism will be explained in more detail. By adjusting an arc set mechanism (not shown), a user can turn the adjustable ring gear 332 to change the circumferential position of the finger 340, which sets one of the arcuate end stops of the sprinkler's rotation. Once the adjustable arcuate end stop is set relative to the fixed stop assembly 310, the fixed stop assembly 310 and the adjustable stop/finger 340 rotate along with the turret 16 to define arcuate end stops of the watering pattern and to set the outer edges of the watering arc.

As the turret rotates in one direction, the fixed stop assembly 310 will eventually approach the spring arm 354. As the biasing element 312 engages the shoulder 362 of the right side arm 354, the biasing element 312 biases the arm 354 inwardly towards the hub 352 and loading it up as a spring. As the sprinkler continues to rotate, the stop element 314 will then slide over the flexed arm end 358 and abut into the flat side or distal end 360 of the unloaded or unbiased second arm 356. This abutment causes the arm spring 320 to toggle in the direction of sprinkler rotation causing a toggle pin 372 to shift within the slot 353, which triggers the gear mechanism to shift direction of rotation. The inwardly biased arm 354 then releases its pressure to snap or push the stop element 314 and help start the turret 16 begin rotating in the opposite direction.

As the turret 16 rotates in the opposite direction, the finger 340 will eventually approach and then engage the spring 320. An inner surface 376 of the finger 340 will engage the left spring arm 356 and depresses the arm inwardly towards the hub 352 to add a spring load or bias force to the arm 356. As the sprinkler turret 16 continues to rotate further, the flat inner wall 378 of the finger 340 will eventually contact or engage the distal end 358 of the right or unbiased arm 354, which results in the spring 320 toggling back in the other direction and shifting the toggle pin 372 in the slot 353 the other direction to again reverse direction of the gear drive mechanism. The inwardly biased arm 356 then releases its pressure to snap or push the finger 340 and help start the turret 16 begin rotating in the opposite direction again. This repeating motion continues back and forth during watering.

In another approach, if the finger 340 or stop element 314 approaches one of the distal ends of the arms 358, 360 in the opposite direction, an angled portion on the back of the finger 340 or stop element 314 allow the arms to slide over the spring without tripping the toggle pin 372. Such a configuration provides the turret with an automated arc memory feature.

If the adjustable ring gear 332 is rotated to contact the biasing element 312, the finger 340 and stop element 314 are bent backwards to allow the distal ends of the arms 358, 360 to pass by free of contact with the finger 340 and stop element 314 to provide for 360 degrees of rotation.

The reversing mechanism of the rotors herein is advantageous because it is positioned, in some approaches, in the upper portions of the turret 16 above a gear drive mechanism. The reversing mechanism is very thin and flat. In some approaches and as illustrated back in FIGS. 4 and 31, the entire reversing mechanism is balanced for shifting left and right and located just underneath the upper cap.

So configured, such an approach provides numerous advantages. The use of a single spring 320 having multiple extending arms 360 & 358 to pivot the toggle pin 372 which in turn provides both clockwise and counter-clockwise rotation allows for a memory arc functionality where the spring action only occurs on one direction for each extending arm on the spring. Additionally, generally speaking, current sprinkler designs incorporate two springs, with each one serving to rotate the mechanism in a different direction. Spring 320 provides a single biasing element to trigger both clockwise and counter-clockwise rotation. That is, one component provides triggering movement in both directions. Due to the use of a single thin spring component, only a small amount of axial or turret space is required to properly configure the reversing mechanism where prior designs with multiple reversing springs required substantially more space to fit the two reversing spring systems.

Further, due to the planar nature of the spring actuation shown in FIG. 33 and described above and the limited amount of vertical displacement in the rotor head needed for the spring 320, the spring 320 may have a slim or small axial profile, which provides for a smaller overall rotary sprinkler configuration and increased cost savings. Such a configuration may result in the use of a smaller turret and exposed area of the turret on the irrigated turf, which in turn may provide for reduced intrusiveness on the turf.

Further still, the configuration of spring 320 may easily be combined with the planetary reversing system and the turbine as previously described. The arms 354 and 356 of the spring 320 are also advantageous because they may engage either the inner ring gear 332 or the outer ring housing 302 and ties or couples both (via the pin 372 and reversing plate 330, for instance) to the stationary center ground rod as generally shown in FIG. 32.

Double Pop-Up Turret

The sprinkler may also include other optional features as needed for a particular application. In some approaches, the sprinkler 10 may include a double pop-up riser stem 14 that elevates out of the housing when pressurized fluid is received in the unit. Once the stem 14 is fully extended, then the turret 16 extends or elevates out of the riser 14 a second distance. This is illustrated in the exemplary images of FIGS. 35A, 35B, and 35C. FIG. 35A shows the sprinkler in a non-watering position with no water being supplied to the sprinkler housing as the entire riser 14 is received in the housing 12. In FIG. 35B, fluid is supplied to the housing 12 under pressure and the riser 14 is elevated out of the housing 12, but the turret 16 has not yet elevated out of the riser 14. Lastly, in FIG. 35C, the sprinkler is in an operational configuration with the turret 16 fully elevated out of the riser 14.

As part of the double-pop-up or turret elevation, the sprinkler 10 may also include one or more dynamic seals to help seal the rotating turret 16 after it has elevated out of the riser 14. FIG. 36 illustrates one example of a dynamic seal 400. These dynamic seals 400 may hinder water from escaping the unit under rotation and when the turret 16 elevates out of the riser. The seals 400 will also function as both a rotary seal and a wiper seal. In one approach, the turret 16 may include two O-ring seals (or other types of sealing members) at the lower portions of the turret 16 as shown in FIG. 36.

Filter Basket

Turning to FIGS. 37 and 38, the sprinkler 10 may also employ a unique filter basket assembly 410 that may be a load bearing or structural member of the sprinkler in addition to providing filtering capacity. In one approach and as shown by the exemplary version in FIG. 37, the filter basket 410 may include a cylindrical outer wall 412 having filter openings therein to filter fluid flowing to the nozzle 40. An upper end of the wall 412 may be secured to the upper end of the riser 14 or a cap thereof. A lower end of the filter basket includes an inwardly projecting dome 414 with a top wall 416 to which the sprinkler shaft 100 may be fixed thereto. Thus, the filter basket 410 retains the lower end of the main structural shaft or rod 100 to which all of the mechanisms (adjustments, gear box, nozzle, deflector, etc.) mount or anchor to. A lower end of the filter basket 410 may also include a retainer 420 that is received by within a lower end of the dome 414 to provide further structural support. By one approach, the retainer 420 may be frictionally fit or pressed into the lower end of the dome 414. In this configuration, the filter basket is capable of withstanding axial and twisting loads similar to an aluminum can, but still retains its structural rigidity even if the side walls 412 can be resiliently flexed inwardly or outwardly under fluid pressure.

The filter basket 410 may also have the unique ability to further function as a pressure regulation mechanism. By one approach, the basket side walls 412 may regulate pressure by distorting some or all of its openings under fluid pressure. This distortion of the flow openings will change the amount of low that can get through the filter and change the pressure and fluid flow therethrough. FIG. 38 is another example of a filter basket 410 for use with the sprinklers herein. In this approach, the filter basket 410 may include one or more raised portions 430 extending outwardly from the outer surfaces of the side wall 412. Under pressure, the raised regions 430 will distort, which will tend to distort a flow passage through the wall 412 so that openings on opposite sides of the wall will become misaligned in the filter wall. This can change the amount of low that will get through the filter and change the pressure and flow. In addition, since the raised regions are flexible, these regions can collapse for insertion into the riser stem 14, but then expand once it is inserted into the sprinkler.

Height Adjustable Deflector

The sprinkler 10 may also employ a height adjustment of the turret 16 to manually regulate flow, perform an automatic deflector purge, and/or perform a manual deflector purge. This height adjustment of the turret 16 will alter the geometry of the deflector exit from the operational configuration. In some forms, such as when using the multi-port deflector 24 discussed herein, the flow rate can be regulated by keeping portions of the deflector 24 exit covered. By one approach, this may be achieved by a stop or other height adjustment mechanism, which upon actuating will limit the elevation height of the turret 16.

The height adjustment of the turret 16 may also be utilized on the sprinkler 10 for an automatic purge cycle each time it is activated for watering. By one approach, this can be achieved by allowing the turret 16 to elevate to a greater height than its set point for normal operation. This additional height allows additional ports 60 in the multi-port deflector 24, for example, to be exposed for fluid flow to allow large pieces of grit or debris to purge the unit. This would, in some approaches, take place on every start-up.

The sprinkler 10 may also be capable of a manual purge whereby a user may be able to manually manipulate the turret 16 upwardly out of the riser 14 to expose additional deflector area for fluid exit to purge any debris or grit from the unit.

Other Features

In another approach, one of the outlet ports of the sprinkler is configured to project fluid outwardly from the deflector at a first trajectory angle relative to horizontal. Further, another outlet port having a different shape is configured to project fluid outwardly from the deflector at a second, different trajectory angle relative to horizontal.

In another aspect, the non-rotating stem of the sprinkler extends along the longitudinal axis of the housing and through the deflector.

In other approaches, the sprinkler drive mechanism is positioned in the rotating turret. The drive mechanism further includes a turbine having turbine blades. The turbine is disposed in the rotating turret such that the turbine blades extend downstream of the deflector and into the fluid being projected therefrom which operates to rotate the turbine for powering the drive mechanism. Further, in some approaches, the turbine blades are configured to deflect upwardly upon contacting water of a sufficient pressure to reduce the torque provided by the rotation of the turbine. The deflector may additionally include a turbine passage defined therein which directs a portion of the fluid flow received by the deflector from the nozzle to engage the turbine blades downstream of the deflector.

In still another approach, the sprinkler includes a reversing mechanism coupled to the drive mechanism operative to shift the rotation of the turret in opposite directions. The reversing mechanism is wholly located within the rotating turret. The reversing mechanism may include a fixed cap mounted to the turret for rotation therewith but is not adjustable relative to the turret. Thus, the cap may provide a non-adjustable fixed arc stop defining one end of the arc of rotation. The cap may define an inwardly projecting abutment defining the non-adjustable fixed arc stop.

The reversing mechanism may include an adjustment ring mounted to the turret for rotation therewith and operative to be adjusted in a circumferential position relative to the turret for setting the arc of rotation. The adjustment ring may include an inwardly projecting finger defining an adjustable arc stop. The reversing mechanism may additionally include a toggle plate coupled to the drive mechanism for reversing the direction of rotation thereof, which may include a central hub mounted to the rotating turret and defining two opposing bias arms extending outwardly from the central hub toward each distal end of the bias arms positioned in the rotating turret to be engageable with one of the inwardly projecting finger of the adjustment ring or the inwardly projecting abutment of the non-adjustable fixed arc stop. Engagement of the finger or abutment to the toggle plate biases one of the arms inwardly and abuts the other of the arms for reversing direction of the turret.

The sprinkler may also include a main housing into which the housing is received. Here, the non-rotating stem of the housing may be configured to extend and retract out of the main housing, and the rotating turret of the housing may be configured to extend and retract out of the non-rotating stem to expose the deflector.

In other approaches, the sprinkler may further include a support shaft extending along the longitudinal axis and through both the nozzle and the deflector. The support shaft may be mounted to a filter element upstream of the nozzle. The filter element may have a plurality of channels extending therethrough for passage of fluid but also have a rigidity sufficient to provide axial structural support for the shaft. The rotating turret may be configured to turn relative to the support shaft.

The filler element of the sprinkler may have a side wall defining the plurality of channels. The side wall may be configured to define a central cavity and further have an inwardly projecting dome in the central cavity to provide the rigidity to the filter element.

In another approach, the sprinkler further includes a filter upstream of the nozzle which includes a filter wall having a flow passage therethrough. The filter wall is configured to deform under fluid pressure to distort the filter wall to regulate pressure flowing through the flow passage. In some approaches, the filter wall surrounds the nozzle.

In another aspect, the nozzle and deflector are operative to provide a flow rate of fluid from the deflector and to project such flow rate a first distance from the sprinkler to a cover a first arc of rotation. The sprinkler further includes an adjustment mechanism to adjust one or both of the deflector or nozzle to provide the same flow rate of fluid but to project the same flow rate of fluid a second, different distance from the sprinkler for a second, different arc of coverage.

It will be understood that various changes in the details, materials, and arrangements of parts and components which have been herein described and illustrated in order to explain the nature of the sprinkler may be made by those skilled in the art within the principle and scope of the sprinkler as expressed in the appended claims. Furthermore, while various features have been described with regard to a particular embodiment, it will be appreciated that features described for one embodiment may also be incorporated with the other described embodiments.

What is claimed is:

1. A rotary sprinkler comprising:
a housing with an inlet for receiving fluid for irrigation, the housing having a longitudinal axis, a non-rotating stem, and a turret mounted for rotation relative to the non-rotating stem;
a drive mechanism for rotating the turret in a reversible arc of rotation relative to the non-rotating stem;
an arc setting mechanism configured upon adjustment thereof to increase or decrease the arc of rotation of the turret;
a nozzle defining an outlet with a variable shape for projecting fluid along the longitudinal axis, the nozzle mounted in the non-rotating stem; and
a deflector mounted for rotation with the turret, positioned for receiving fluid from the nozzle along the longitudinal axis, and configured to project the received fluid outwardly from the sprinkler;

2. The rotary sprinkler of claim 1, further comprising an adjustment mechanism coupled to the arc setting mechanism configured to automatically adjust one or both of the nozzle or the deflector to maintain a substantially constant flow rate of fluid and a substantially constant throw distance from the deflector relative to the selected arc of rotation incident to changes in the arc setting mechanism.

3. The rotary sprinkler of claim 1, wherein the variable shape nozzle includes a plurality of circumferentially spaced lobes arranged and configured to axially shift upwardly or downwardly to change the shape of the nozzle outlet incident to an arc setting adjustment.

4. The rotary sprinkler of claim 3, wherein the variable shape nozzle has a non-symmetrical shape formed by one or more of the circumferentially spaced lobes being absent forming an enlarged nozzle outlet opening.

5. The rotary sprinkler of claim 4, further comprising an axially shiftable plunger upstream from the non-symmetrical shaped nozzle forming a flow cavity therebetween, the axially shiftable plunger movable towards and away from a valve seat on an upstream side of the flow cavity.

6. The rotary sprinkler of claim 1, further comprising the non-rotating stem extending along the longitudinal axis and extending through the nozzle.

7. The rotary sprinkler of claim 3, wherein the variable shape nozzle includes an axially shiftable adjustment element coupled to the circumferentially spaced lobes, the axially shiftable adjustment element having a lower surface with a profile thereof abutting the nozzle lobes to either push the lobes downwardly or permit the lobes to shift upwardly.

8. The rotary sprinkler of claim 7, wherein the lower surface profile of the axially shiftable adjustment element has a non-linear profile.

9. The rotary sprinkler of claim 1, wherein the variable shape nozzle is an iris having two halves shiftable relative to each other incident to an arc setting adjustment.

10. The rotary sprinkler of claim 1, wherein the variable shape nozzle has a nozzle body defining a plurality of inlet ports with each inlet port in fluid communication with a flow channel extending through the nozzle body.

11. The rotary sprinkler of claim 10, wherein each nozzle inlet port has a cover shiftable between an open position to permit fluid flow into the port's associated channel and a closed position blocking fluid flow into the associated channel, and wherein each cover can be actuated between open and closed positions independently of the other covers incident to an arc setting adjustment.

12. The rotary sprinkler of claim 1, wherein the variable shape nozzle includes one or more concentric cones defining an outlet opening at a downstream end thereof, each of the concentric cones axially shiftable relative to each other to change the shape of the nozzle outlet incident to an arc setting adjustment.

13. The rotary sprinkler of claim 12, wherein the one or more concentric cones are coupled with a ratchet member configured to selectively engage and release individual cones for axial shifting.

14. The rotary sprinkler of claim 12, wherein an outer cone includes a slot having an axial portion along the longitudinal axis and a lock portion transverse to the longitudinal axis and an inner cone includes a tab received in the slot, and when the tab is in the axial portion of the slot, the outer cone is permitted to shift and when the tab in the in lock portion of the slot, the outer cone is restrained from shifting.

15. The rotary sprinkler of claim 1, wherein the variable shape nozzle includes a resilient tube defining a flow passage therethrough, a member enrobing the resilient tube, and an adjustment device configured to constrict or release the enrobing member about an outer surface of the resilient tube to either decrease or increase the size of the flow passage defined by the resilient tube incident to an arc setting adjustment.

16. The rotary sprinkler of claim 1, wherein the deflector defines an outlet opening having a plurality of downwardly extending vanes therein.

17. The rotary sprinkler of claim 1, wherein the deflector defines an outlet opening having opposing side edges with a stepped profile to form deflection tiers for projecting fluid received from the nozzle.

18. The rotary sprinkler of claim 1, wherein the deflector has a body defining a plurality of inlet ports and a plurality of outlet ports with a flow channel extending between a pair of inlet and outlet ports.

19. The rotary sprinkler of claim 18, wherein the deflector is axially shiftable out of the non-rotating stem such that a variable number of the outlet ports are capable of being exposed for directing fluid outwardly from the sprinkler based on the axial position of the deflector.

20. The rotary sprinkler of claim 19, further comprising a dynamic seal capable of providing a substantially water tight seal between the deflector and non-rotation stem upon axial and rotational movement of the deflector.
